(19) United States
(12) Patent Application Publication
(10) Pub. No.: US 2022/0018147 A1
(43) Pub. Date: Jan. 20, 2022

(54) HUNTING OR OBSERVATION BLIND

(71) Applicants: David A. Eicher, JR., Grabill, IN (US); Merlin A. Eicher, Grabill, IN (US); Jesse James Eicher, Grabill, IN (US); David Eicher, SR., Grabill, IN (US); Anna Mae Eicher, Grabill, IN (US); Allen A. Eicher, Grabill, IN (US); Anna Eicher, Grabill, IN (US); Joseph A. Eicher, Grabill, IN (US); Jonathon A. Eicher, Grabill, IN (US)

(72) Inventors: David A. Eicher, JR., Grabill, IN (US); Merlin A. Eicher, Grabill, IN (US); Jesse James Eicher, Grabill, IN (US); David Eicher, SR., Grabill, IN (US); Anna Mae Eicher, Grabill, IN (US); Allen A. Eicher, Grabill, IN (US); Anna Eicher, Grabill, IN (US); Joseph A. Eicher, Grabill, IN (US); Jonathon A. Eicher, Grabill, IN (US)

(21) Appl. No.: 17/377,819

(22) Filed: Jul. 16, 2021

Related U.S. Application Data
(60) Provisional application No. 63/052,527, filed on Jul. 16, 2020.

(51) Int. Cl. E04H 1/12; E05F 15/53

(52) U.S. Cl. CPC E04H 1/1205; A01M 31/025; E05F 15/53

(57) ABSTRACT

An elevated hunting or observation blind enclosure formed by interconnected outer walls. A door is pivotally mounted to one of the outer walls to span substantially span from the top to the bottom of the one outer wall. The door is hinged at its top edge to swing out from a vertical closed position to an open position permitting unobstructed entrance and exit by a user.

### CROSS REFERENCE TO RELATED APPLICATIONS

This is a non-provisional application based upon U.S. provisional patent application Ser. No. 63/052,527, entitled “HUNTING BLIND”, filed Jul. 16, 2020, which is incorporated herein by reference.

### BACKGROUND OF THE INVENTION

### 1. Field of the Invention

The present invention is in the field of hunting or observation blinds, and more particularly to those of the elevated type.

### 2. Description of the Related Art

In the field of hunting or observation blinds, it has long been recognized that elevating the blind above the normal field of vision for whatever game is being hunted or observed is advantageous. While this provides an enhanced ability to view and observe, it also carries with it risks and difficulties associated with climbing to an elevated position. The problems are made more acute by the fact that a user usually has to carry gear that may be bulky or heavy. This makes it difficult to ascend to an elevated hunting or observation blind and to actually enter the blind.

Accordingly, what is needed in the art is an elevated blind that permits unobstructed entrance and exit.

### SUMMARY OF THE INVENTION

The present invention provides a hunting or observation blind that is elevated and permits safe, unobstructed entry and exit.

The invention, in one form, is a hunting or observation blind including a floor elevated above the ground and a plurality of outer walls extending from the floor and interconnected to form an enclosure. At least a portion of one outer wall has a door pivotally mounted at its top to swing out and provide unobstructed entry to and exit from the enclosure.

The invention, in another form, is elevated with a self-supporting structure not dependent on adjacent trees.

In another form the invention may be supported in an elevated position by an adjacent tree.

One advantage of the present invention is the ability to safely enter and exit an elevated enclosure, particularly when carrying gear and equipment.

Another advantage is that protection is provided from the elements while a user makes their entrance or exit.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an elevational view of a hunting or observation blind embodying the present invention in a self-supporting structure;

FIG. 2 is a side view of the hunting or observation blind illustrated in FIG. 1 with an access door in its open position;

FIG. 3 is a view of the door shown in FIG. 2 in a closed position; and

FIG. 4 shows a hunting or observation blind supported in an elevated position by connection to an existing tree.

Corresponding reference characters indicate corresponding parts throughout the several views. The exemplifications set out herein illustrate several embodiments of the invention and such exemplifications are not to be construed as limiting the scope of the invention in any manner.

### DETAILED DESCRIPTION OF THE INVENTION

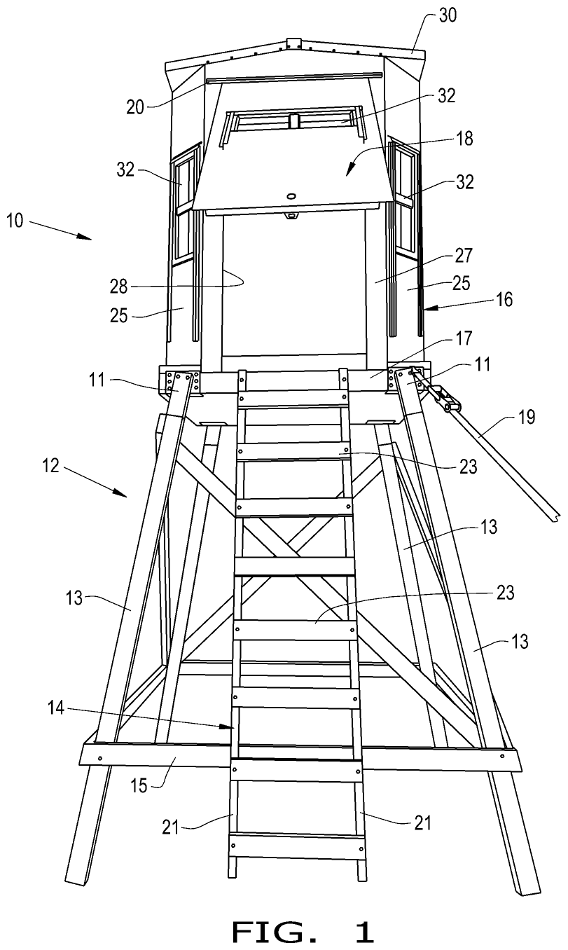

Referring now to the drawings, and more particularly to FIGS. 1-3, there is shown a hunting or observation blind 10. The hunting or observation blind 10 may provide a usable outdoor space or temporary dwelling for one or more individuals. The hunting or observation blind 10 may be used for any desired recreational activity, such as bird watching or hunting. The hunting or observation blind 10 may generally include a stand or raised platform 12, a ladder 14, an enclosure 16, and a hinged door 18 for allowing the user(s) to easily enter or exit the enclosure 16.

The platform 12 may elevate and support the enclosure 16. The platform 12 may be composed of multiple interconnected support members. For example, the platform 12 may include four or more main support beams 13, one or more cross-beams 15 for supporting the main support beams 13, a floor 17 or base connected to the top of the main support beams 13, and/or one or more brackets 11 for connecting the beams 13 and/or the floor or base 17 with one another. The platform 12 may be anchored or otherwise secured to the ground via concrete anchoring members or anchoring straps 19. The platform 12 may comprise any desired material, such as wood and/or metal.

The ladder 14 may be fixedly or removably connected to the platform 12. For example, as shown, the ladder 14 may be fastened to the platform 12; and thus, the ladder 14 may be integrated as part of the platform 12. The ladder 14 may include a pair of vertical rail members 21 connected to the platform 12 and multiple horizontal step members 23 connected to the rail members 21. The ladder 14 may comprise any desired material, such as wood and/or metal.

The enclosure 16 may be connected to and supported by the platform 12. The enclosure 16 may define the enclosed usable space which the user(s) may temporarily inhabit. The enclosure 16 may include any desired members, such as outer walls 25, 27, connected to the floor 17 and interconnected. The outer walls 25, 27 may be connected to support beams, panels, brackets, fasteners, etc. (not shown) which together comprise the enclosure 16. The enclosure 16 may include a roof 30 supported by the outer walls 25, 27.

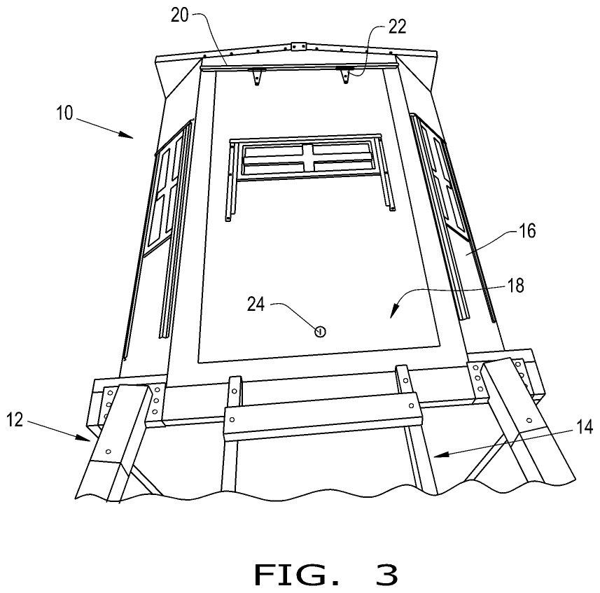

The enclosure 16 may include a door-cutout or access opening 28 on one outer wall 27 for accommodating the door 18. In other words, the outer wall 27 or front panel may have a rectangular cutout 28 which accommodates the door 18 and allows the user(s) to pass therethrough to enter or exit the enclosure 16. The enclosure 16 may include a mounting member 20 for mounting the door 18. The mounting member 20 may be affixed to the outside of the outer wall 27 or side of the enclosure 16. The mounting member 20 may be in the form of a beam which extends outwardly away from the wall 27 to form an eave deflecting rain from the top of the door 18. The enclosure 16 may also have one or more hinges 22 interconnected in between the mounting member 20 and the door 18 (FIG. 3). The hinges 22 may be in the form of any desired hinges 22.

The enclosure 16 may also include one or more selectively closable windows and/or cutouts 32. The enclosure 16 may comprise any desired material, such as a canvas, metal, and/or plastic material.

The door 18 is hingedly connected to the outer wall 27 of the enclosure 16. More particularly, the door 18 is pivotally connected to the underside of the mounting member 20 via hinges 22. The door 18 is pivotable in between a closed position shown in FIG. 3 and an open position shown in FIG. 1. The door 18 may be considered a top-mounted pivotable door 18 that opens upwardly and outwardly away from the bottom of the enclosure 16. The door 18 is located adjacent to the ladder 14. The door 18 substantially spans from the top to the bottom of the enclosure 16.

The door 18 may have a shape and size which corresponds to the shape and size of the door-cutout 28 on the outer wall 27 of the enclosure 16. The periphery of the door 18 may at least partially extend over the outer surface of the outer wall 27. For instance, the door 18 may have one or more lip sections that overlap on top of the enclosure 16 while the remaining inner portion of the door 18 abuts up against the inside perimeter of the door-cutout 28. The door 18 may comprise any desired material, such as a canvas, metal, and/or plastic material. The door 18 may or may not be comprised of the same material as the enclosure 16.

The door 18 may also include a locking feature 24 for selectively locking the door 18. The locking feature 24 may be in the form of any desired locking mechanism, such as a key and deadbolt combination lock. The door 18 may also include one or more windows 32. Additionally, the door 18 may include one or more handles 34 which are located on the inside and/or outside of the door 18. The door 18 and/or the enclosure 16 may or may not include a weather seal. For instance, the door 18 may include a material that extends along the perimeter of the door 18 for weather sealing the enclosure 16.

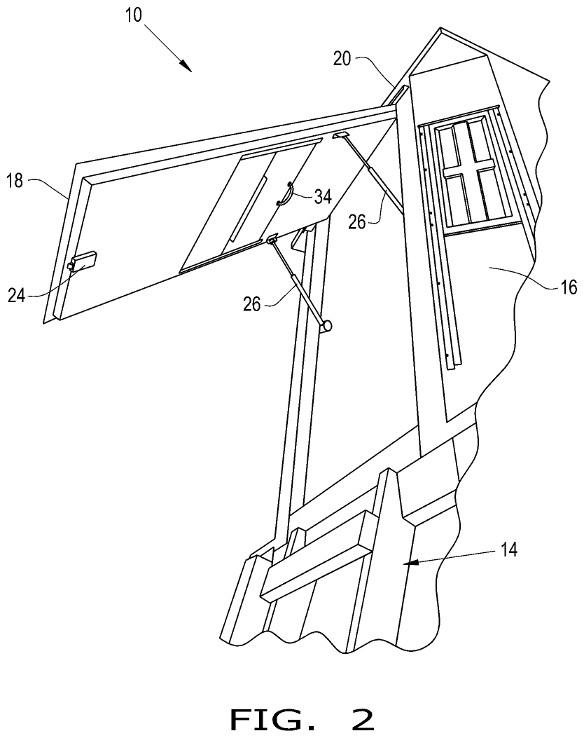

The door 18 may be configured as a manual door, a semi-automatic door, and/or fully-automatic door 18. For example, the door 18 may or may not include one or more linkages which connect the door 18 to the enclosure 16; and thereby, the user may manually lift and lower the door 18. Additionally or alternatively, the door 18 may or may not include one or more actuators 26 which assist the user in opening and/or closing the door 18 (FIG. 2). The actuators 26 may also hold the door 18 open in its open position. Hence, while the door 18 is held open by the actuators 26, the user may slip through the door-cutout without the door 18 encumbering and/or otherwise contacting the user or the user's equipment. The actuators 26 may be connected in between the door 18 and the enclosure 16. More particularly, a pair of actuators 26 can be connected in between the inside of the outer wall 27 of the enclosure 16, adjacent to the door-cutout 28, and the backside of the door 18. The actuators 26, for example, may be in the form of pneumatic lift support struts which assist the user in manually opening and/or closing the door 18. It should be appreciated that the door 18 may also include one or more actuators which automatically open or close the door 18. Therein, the actuators may be in the form of cylinders, such as electric, pneumatic, or hydraulic cylinders which are selectively actuated by an electrical processing circuit, e.g. a controller, and one or more user inputs, e.g. buttons, switches, etc.

In operation, a user may initially climb the ladder 14. Upon approaching the top of the ladder 14, the user may unlock the door 18 via the locking feature 24. Thereafter, the user may lift the door 18. The actuators 26 may thereby assist the user in lifting and holding the door 18 in its open position. Once the door 18 is in its open position, the user may access the enclosure 16 directly from the top of the ladder 14. Thereby, the user simply steps up and into the enclosure 16. Once inside the enclosure 16, the user may grab the handle 34 on the door 18 and accordingly lower and close the door 18 in order to position the door 18 in its closed position. To exit the enclosure 16, the user may initially open the door 18. Thereafter, the user may exit through the door-cutout 28 with his/her legs first and head trailing. While still on the ladder 14, the user may subsequently close the door 18. Hence, the user is able to maintain a low center of gravity while entering or exiting the enclosure 16. Therefore, the user may easily and safely enter or exit the enclosure 16 as desired. Since the door 18 opens outward, it provides the user protection from the elements when entering or exiting the enclosure 16.

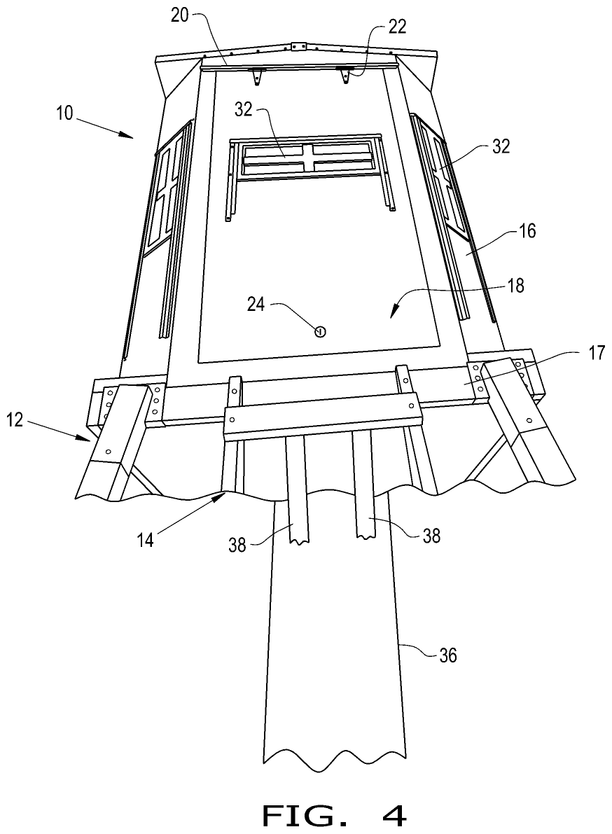

The embodiment of the invention shown in FIGS. 1-3 is self supporting through the use of the platform 12. The embodiment of FIG. 4 may be supported in an elevated position by a separate structure such as a tree 36. In this embodiment, the floor or base 17 of the enclosure 18 may be supported in a cantilever fashion by beams 38 that may be temporarily or permanently attached to the tree 36. Appropriate fastening elements (not shown) may be used to provide a reliable structural support of the enclosure 16 by the tree 36. In this embodiment, the ladder 14 may be attached to the floor or base 17. The embodiment of FIG. 4 provides the same benefits of entry and exit as in FIGS. 1-3.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hunting or observation blind comprising:
a floor elevated above the ground;
a plurality of outer walls extending from said floor and interconnected to form an enclosure; and
wherein at least a portion of one outer wall has an opening and a door pivotally mounted at its top to swing out and provide unobstructed entry to and exit from said enclosure.

2. A hunting or observation blind of claim 1, wherein said opening and door substantially span from the top to the bottom of said one outer wall.

3. The hunting or observation blind of claim 1, further comprising an actuator to assist pivoting movement of and positioning of said door away from its closed position.

4. The hunting or observation blind of claim 3, wherein said actuators are pneumatic springs.

5. The hunting or observation blind of claim 1, further comprising a locking apparatus at the base of the door.

6. The hunting or observation blind of claim 5, further comprising a handle on the side of the door facing the enclosure interior and positioned to facilitate closing of the door from the interior of the enclosure.

7. The hunting or observation blind of claim 1, wherein said door overlaps the opening in said outer wall.

8. The hunting or observation blind of claim 1, further comprising an observation window in at least one of the door and outer walls.

9. The hunting or observation blind of claim 1, further comprising an eave positioned over the top of the door to deflect rain.

10. The hunting or observation blind of claim 9, wherein the door is pivotally mounted to the eave by hinges.

11. The hunting or observation blind of claim 1, further comprising a self-supporting platform on which the floor is mounted.

12. The hunting or observation blind of claim 11, further comprising a ladder mounted on the self-supporting platform and extending substantially from the base of said self-supporting platform to said floor.

13. The hunting or observation blind of claim 1, further comprising apparatus for structurally connecting said blind to a preexisting tree.

14. The hunting or observation blind of claim 13, further comprising a ladder supported by and extending from said floor to the ground adjacent the tree.

15. The hunting or observation blind of claim 1, further comprising a roof extending over said interconnected outer walls.
